(19) United States
(12) Patent Application Publication
(10) Pub. No.: US 2019/0308438 A1
(43) Pub. Date: Oct. 10, 2019

(54) Flat Binder Clip

(71) Applicant: James F. Machen, Toledo, OH (US)

(72) Inventor: James F. Machen, Toledo, OH (US)

(21) Appl. No.: 15/945,431

(22) Filed: Apr. 4, 2018

(51) Int. Cl. B42F 1/08

(52) U.S. Cl. CPC B42F 1/08; F16B 2/248

(57) ABSTRACT

This invention relates to a type of paper clip known as a binder clip. Binder clips are a class of clips -suitable for binding together thicker stacks of paper or other thin sheets, up to a stack ⅝ inch thick, or approximately 125 sheets. Typical binder clips currently available on the market are comparably bulky and heavy, and add thickness above the height of a stack. As an improvement, this invention has a quite flat, low and compact configuration and is light in weight, which overcomes these typical problems. Additionally, it can provide a flat surface to accommodate writing or advertising graphics.

### FIELD OF THE INVENTION

This invention relates to a binder clip for multiple sheets of paper, documents or the like, and more specifically to a binder clip which can firmly clamp together a few sheets, while also accommodating relatively thick stacks of paper or other articles. In either case it maintains an essentially flat configuration. It may also have other uses, such as for a money clip.

### BACKGROUND

A wide variety of clips, both simple and complex, have been in universal use for well over a century. The simplest and most ubiquitous form of paper clip is sheets, various types of binder clips have been devised, some quite ingenious. A common binder clip design is shown in FIG. 1.

A major drawback of typical binder clips is that their clamping elements add significant additional thickness on top of the sheets clamped. Thus they are not suitable for use inside a file folder. Also, multiple clipped packs when stacked, become awkward with excessive bulkiness.

Typical binder clips are somewhat unwieldy to use, requiring excessive finger pressure to open widely for multiple sheet insertion. Also they are otherwise bulky and comparatively heavy.

### OBJECTS AND ADVANTAGES

Accordingly, it is an object of this invention to provide a compact binder clip that is suitable for use with a few sheets or up to 100 or more sheets.

Another object of this invention is to provide a binder clip that lays very flat to the sheets being clipped, with minimal projection above the surface of the sheets.

Another object of this invention is to provide a binder clip that is well suited to being included in a file folder with minimal additional bulkiness.

Another object of this invention is to provide a binder clip which when multiple clipped packs are stacked, will not add excessive bulkiness.

Another object of this invention is to provide a binder clip which requires lighter finger forces to apply, even for many sheets or thicker items.

Another object of this invention is to provide a binder clip which is simple in construction and low in cost.

Another object of this invention is to provide a binder clip which incorporates a surface for writing or marking, for identification, or for use as an advertising specialty.

### DESCRIPTION OF THE DRAWINGS

FIG. 1 is a perspective view of a widely used type of spring steel binder clip which is bulky and requires excessive finger force to use.

FIG. 2 is a perspective view of a preferred embodiment of this invention.

FIG. 3 shows three orthographic views of wire-form 11 of the preferred embodiment.

FIG. 4 shows two views of platen 12 of the preferred embodiment.

FIG. 5 gives two views of the method of applying the preferred embodiment to a stack of sheets.

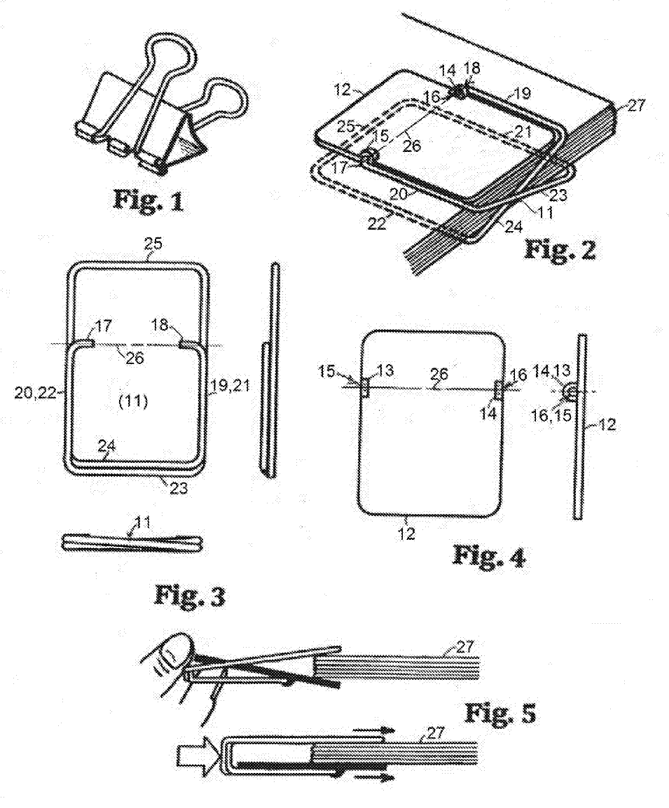

Referring to FIGS. 2, 3, and 4, the various elements and features of this embodiment are identified: a wire-form 11 and a platen 12. Wire-form 11 is made of a resilient material such as steel spring wire, and has eight right-angle bends alternating with nine straight sections, resulting in the configuration shown. Multiple sheets of paper 27 are shown gripped by the preferred embodiment

In the preferred embodiment, wire-form 11 acts as a three-dimensional spring element wherein straight sections 19, 20, 21, and 22 act as cantilever flexing members, while straight sections 23 and 24 act as torsional flexing members. Together, these flexing elements act together to provide the clamping forces and resiliency necessary to meet the design requirements of this novel clip. Platen 12 is made of relatively thin, flat, and rigid material, such as plastic or metal. Platen 12 has two projecting ears 13 and 14 and having cylindrical holes 15 and 16, respectively, with common centerline 26. Short end sections 17 and 18 of wire-form 11 are inserted into holes 15 and 16, respectively. Said holes mate and pivotably engage said end sections, thereby combining wire-form 11 and platen 12 into a unitary assembly which comprises the device of this invention.

While the embodiment of this invention described above is the preferred embodiment, those skilled in the art should recognize that various modifications are possible without departing from the scope of the invention. For instance, modified irregular rectangular design could be included with such scope.

While the embodiment of this invention described above is the preferred embodiment, those skilled in the art should recognize that various modifications are possible without departing from the scope of the invention. For instance, modified irregular rectangular design could be included with such scope. Likewise, a rounded platen surrounded by a suitable mating wire-form could be devised, accomplishing the same objects of this invention, within the scope of the following claims:

I claim:

1. A binder clip comprising two elements: a spring wire-form having nine straight sections wherein each of said sections is joined by a 90 degree bend with it adjacent section, and wherein a first short straight section and a last straight section of said wire-form extend inwardly and are colinear; and a platen mating with the wire-form wherein said first and last straight sections respectively pivotably engage holes in projections extending from said platen.

2. A binder clip comprising a spring wire-form surrounding and pivotably engaging a platen, wherein the general plane of the wire-form is essentially coplanar with the platen.

3. A binder clip according to claim 1 wherein the platen is made of rigid non-metallic material.

4. A binder clip according to claim 1 wherein the platen is made of metal.

5. A binder clip according to claim 1 wherein the platen may have graphics and/or written characters.
